(19) United States
(12) Patent Application Publication
(10) Pub. No.: US 2004/0189985 A1
(43) Pub. Date: Sep. 30, 2004

(54) Garden and home Light Meter

(76) Inventor: michael jules lavergne, hopedale, MA (US)

Correspondence Address: MICHAEL LAVERGNE, 1-A AIRPORT DRIVE, HOPERDALE, MA, 01747, US

(21) Appl. No.: 10/249,241

(22) Filed: Mar. 25, 2003

(51) Int. Cl. G01J 1/42

(52) U.S. Cl. 356/218

(57) ABSTRACT

This unit is a self contained light measuring and recording apparatus. It measures the intensity of sunlight over a specified period of time. The meter may be placed in any area of any choosing. The light meter will record the different intensity of light for that location. The recorded data is separated and stored into its respective readings. Readings are then output to the LCD viewing screen. The data is out put to the LCD in a percentage format indicating full-sun, partial sun and shade.

### BRIEF DESCRIPTION OF DRAWINGS

FIG. 1 side view showing two (2) function buttons, Spring Clip, body and LCD screen.

FIG. 2 showing body cap.

FIG. 3 showing top view of body.

### DETAILED DESCRIPTION

### Background of Invention

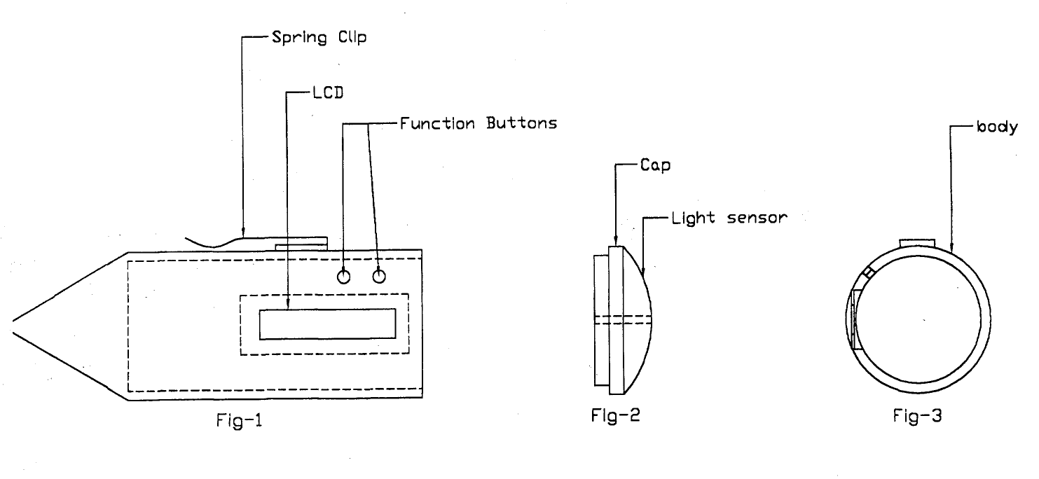

Light meters have been around for years and used in many different industries and hobbies. This light meter was designed to measure light intensity falling in a set area, over a measured length of time. It is a self contained unit. The readings obtained by the meter are stored on an electronic board. Prompted by the use of the function buttons, the light meter then outputs the appropriate data (as requested via function buttons) to a viewing screen, where the data is indicated in percentages of light intensity. The purpose to be: the indication of direct sunlight, partial sunlight, and full shade. This will allow for proper placement of foliage and/or plant based on the known standards of necessary light requirement for any particular type of foliage and/or plant. The Garden and Foliage Light Meter is made of high impact plastic and is circular in design. One end is open to allow for the insertion of the light sensing electronics. It is then fitted with a plastic cap to seal the unit (see FIG. 2). The cap to the unit also contains the light sensor (see FIG. 2). The other end is pointed to allow the unit to be pushed into soft soil (see FIG. 1). There is a spring clip on unit (FIG. 1 and FIG. 3). FIG. 1 shows a LCD Screen on side view and 2 function buttons.]

What is claimed:

1. A self contained light measuring device comprised of the following:
plastic case
plastic cap
display screen (LCD)
light sensing element
electronic control board
Spring clip
function buttons
battery pack

2. The light measuring device of claim 1 having light sensing elements attached to plastic cap and further electrical connection to electronic control board.

3. The light measuring device of claim 1 having the control board mounted inside plastic case.

4. The light measuring device of claim 1 having the display screen mounted to plastic case and connection to electronic control board.

5. The light measuring device of claim 1 having the plastic cap attached to the open end of the plastic case.

6. The light measuring device of claim 1 having function buttons mounted through plastic case.

7. The light measuring device of claim 1 having a spring clip attached to plastic case.

8. The light measuring device of claim 1 having a battery mounted inside plastic case and further electrical connection to electronic control board.

9. The light measuring device of claim 1 having a plastic case pointed on one end and opened on the other end.

10. The control board of claim 3 to record data over a set time period and output data.

11. The LCD screen of claim 1 to show percentages of light intensity obtained from the data stored on the electronic control board.
